(19) United States
(12) Patent Application Publication
(10) Pub. No.: US 2021/0364131 A1
(43) Pub. Date: Nov. 25, 2021

(54) Device for Self-Service Exchange of Cylinders, in Particular Gas Cylinders

(71) Applicant: Gas Key Cage Sp. Z. O. O., Warszawa (PL)

(72) Inventor: Michal CZECHOWSKI, Warszawa (PL)

(21) Appl. No.: 16/768,913

(22) PCT Filed: Nov. 21, 2018
(86) PCT No.: PCT/IB2018/059192

§ 371 Date: Jun. 2, 2020

(30) Foreign Application Priority Data
Dec. 2, 2017 (PL) PL423674

(51) Int. Cl. F17C 13/08; G07F 7/06

(52) U.S. Cl. CPC F17C 13/084; G07F 7/0609; F17C 2205/013; F17C 2205/0111; F17C 2201/058; F17C 2201/0104

(57) ABSTRACT

The present disclosure is directed to a device for the self-service exchange of cylinders, in particular, gas cylinders, including n unilaterally opened boxes for a cylinder, arranged in such a manner that the open walls of the boxes are substantially in one plane, with n being greater than or equal to 2, at least one sliding door, preferably n−1 sliding doors, with a size allowing at least one box to be closed and slide-mounted, so that opening one box by sliding the door causes the closing of another box, and a key lock, which in the open position allows a closed box to be opened by sliding the door, and in the closed position prevents the door from moving by a distance allowing access to the box.

The subject of the invention is a device for self-service exchange of cylinders, in particular gas cylinders, and more specifically a device enabling the exchange of an empty cylinder for a full cylinder.

Existing solutions for devices for exchanging cylinders were based on traditional cages, with a trained employee of the point of sale having access. Due to the participation of staff, the purchase process was complicated and time-consuming. The participation of the point of sale employee engendered a number of problems, including, primarily, the cost.

Other solutions available on the market are fully automated, electro-mechanical self-service devices—Gas Cylinder Vending. They are an alternative to traditional cages and allow the exchange of gas cylinders without service personnel. The customer makes the payment themselves at the device. Then the built-in computer allows the customer to perform the exchange process. Gas Cylinder Vending is a solution that gives a number of benefits, such as the ability to change prices online, optimisation of logistics costs, remote monitoring, etc. However, due to the use of electronic components, it is also a costly solution, susceptible to breakdowns and acts of vandalism.

The subject of the invention is therefore to provide a mechanical device for exchanging gas cylinders, which would allow the customer to replace gas cylinders unaided using a previously purchased mechanical key, without the participation of trained personnel.

The subject of the invention is a device for self-service exchange of cylinders, in particular gas cylinders, characteristic by the fact that it comprises:

n unilaterally opened boxes for a cylinder, arranged in such a manner that the open walls of the boxes are substantially in one plane, with n being greater than or equal to 2,
at least one sliding door, preferably n−1 sliding doors, with a size allowing at least one box to be closed and slide-mounted, so that opening one box by sliding the door causes the closing of another box, and
a key lock, which in the open position allows a closed box to be opened by sliding the door, and in the closed position prevents the door from moving by a distance allowing access to the box.

Preferably, the boxes are arranged in a row, at one height, preferably side-by-side or so that adjacent boxes have common side walls.

Preferably, the lock is mounted in the device housing, preferably in a beam, most preferably between two boxes.

Preferably, the door is equipped with a cover for the key attached to the lock in such a manner that sliding the door after opening the lock causes the key placed in the said lock to be covered.

The device preferably comprises a door-blocking mechanism preventing the door from sliding in the direction opposite to the direction in which the door can be moved after opening the lock.

Preferably, the reversing block mechanism comprises a toothed bar and a ratchet mechanism, of which one is mounted on the door.

Preferably, the device is equipped with a service mechanism used to pry open the ratchet mechanism and release the toothed bar.

Preferably, the service mechanism includes a rod for prying open the ratchet mechanism, which preferably is on at least one end provided with an opening through which a pin blocking the rod can pass.

Preferably, the device comprises an escutcheon covering the lock with a slot for the key allowing only a key of a particular type, and preferably with a designation of the cylinder type.

Preferably the device is equipped with a checking mechanism that prevents opening the box without depositing an empty cylinder in an empty box.

Preferably, the checking mechanism is a weighing mechanism.

Preferably, the weighing checking mechanism comprises a plate adapted for placement of a cylinder thereon and a tie-rod, such that when the weighing plate is loaded, the tie-rod releases the lock block, preferably by a spring, allowing the key to be turned in the lock.

Preferably, the tie-rod is mounted in the beam.

Preferably, the door is mounted on a guide, in which it moves by means of a slide bearing.

Preferably, in its lower part the door is bent towards the box and in the bend a roller bearing is mounted that slides along a bar attached to the device.

According to the invention, the device is a purely mechanical solution that allows self-service replacement of an empty cylinder with a full cylinder. Its sliding-door-based construction allows the implementation of a number of safeguards against fraud, i.e. collecting a full cylinder without leaving an empty cylinder or removing the key after making the purchase.

The invention will now be described in more detail as an embodiment, with reference to the accompanying figures showing:

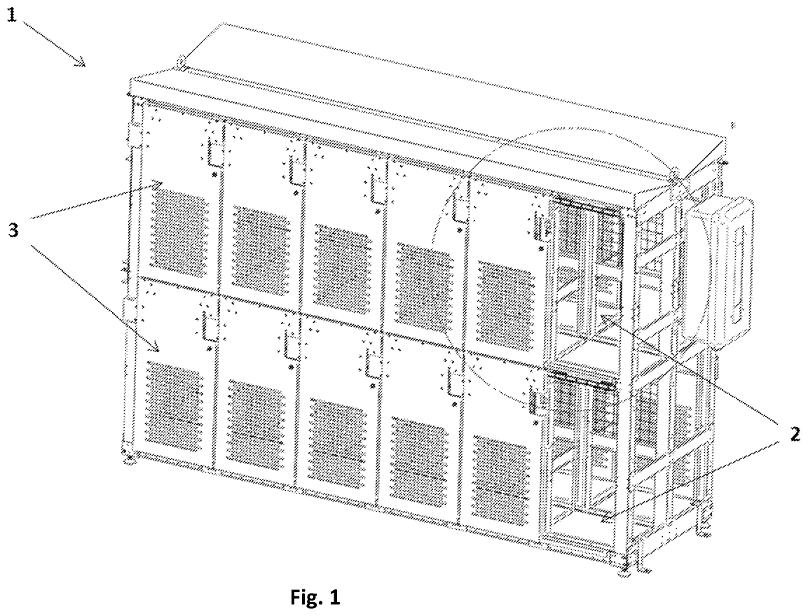

FIG. 1—device for exchanging gas cylinders in a perspective view,

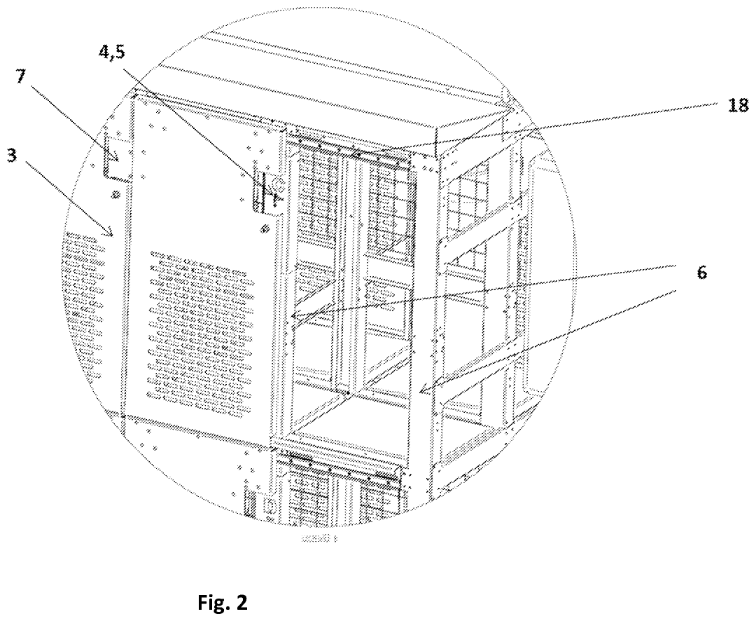

FIG. 2—enlarged fragment of the device indicated in FIG. 1,

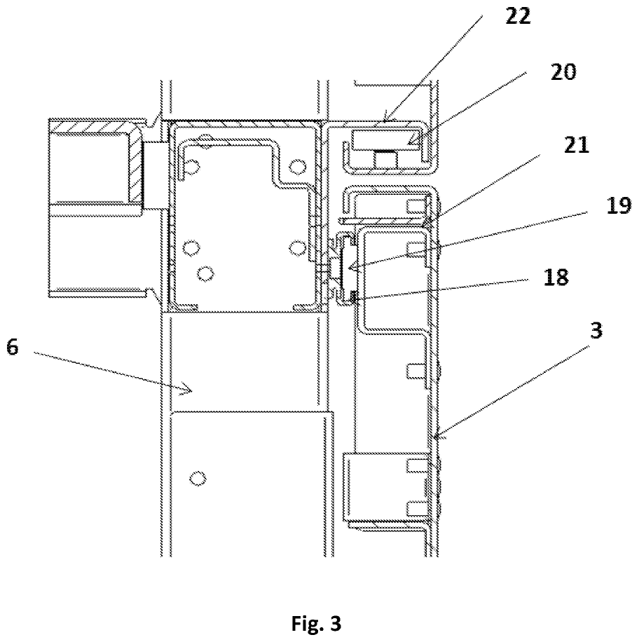

FIG. 3—side view of the mounting of the upper and lower part of the door on the device,

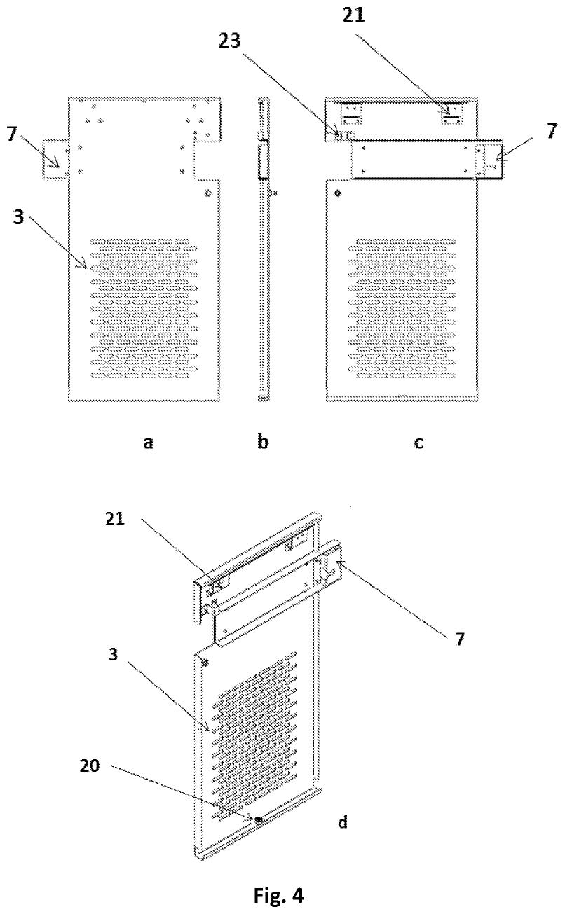

FIG. 4—door in a front (a), side (b), rear (c) and perspective view (d),

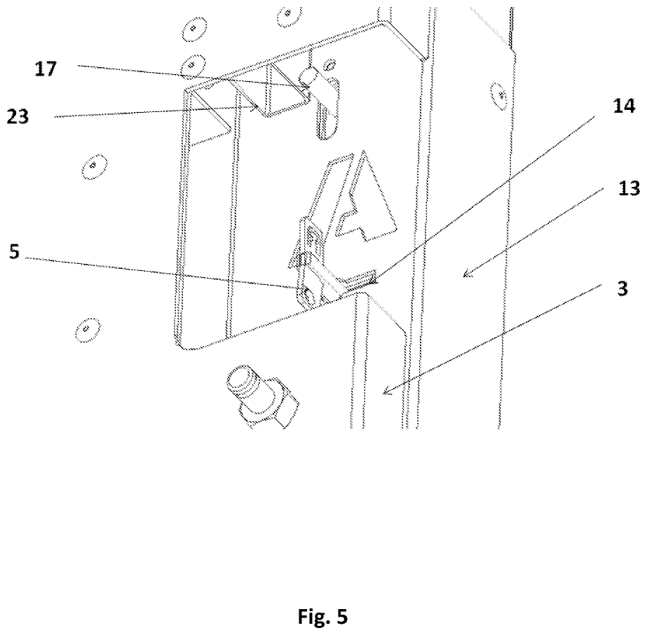

FIG. 5—enlarged fragment of the device including the key lock,

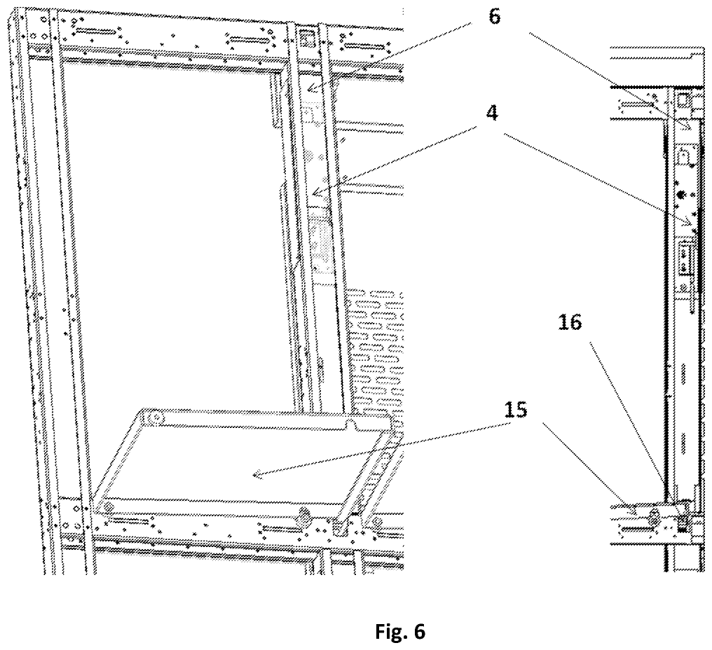

FIG. 6—checking mechanism,

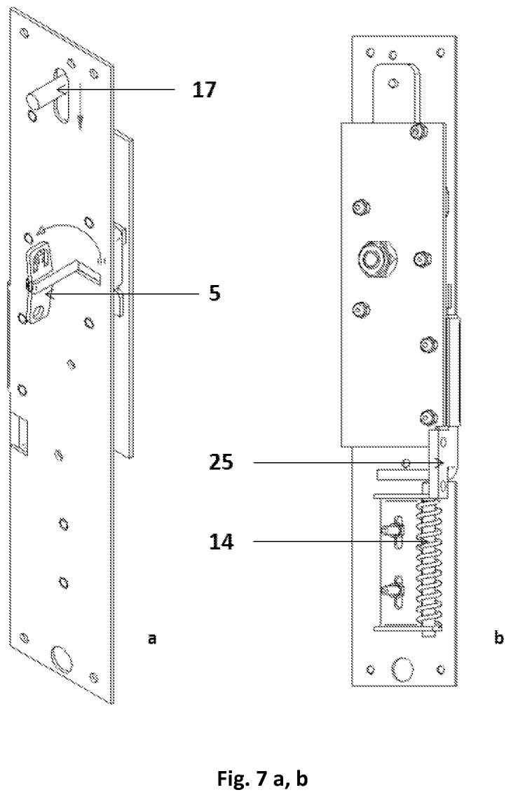

FIG. 7—lock views: front (a), rear (b), rear without cover in locked position (c), rear without cover in unlocked position (c),

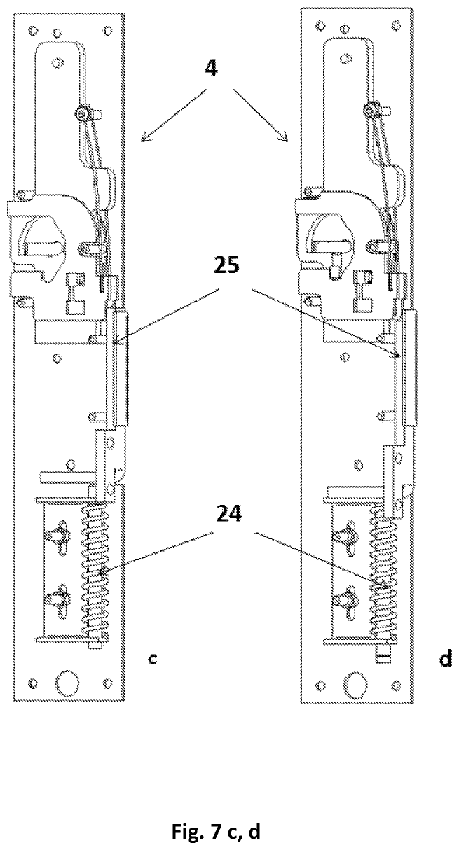

FIG. 8—mechanism blocking door from reversing,

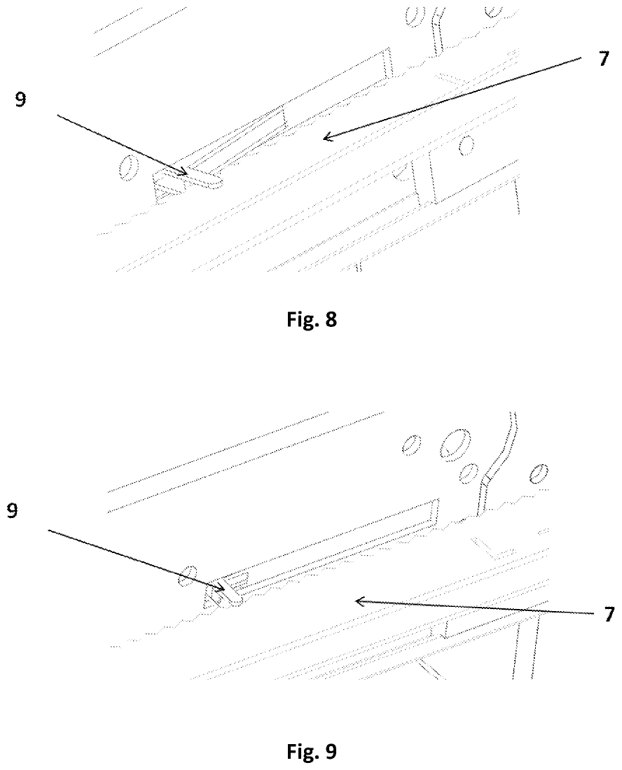

FIG. 9—mechanism blocking door from reversing in the unlocked position,

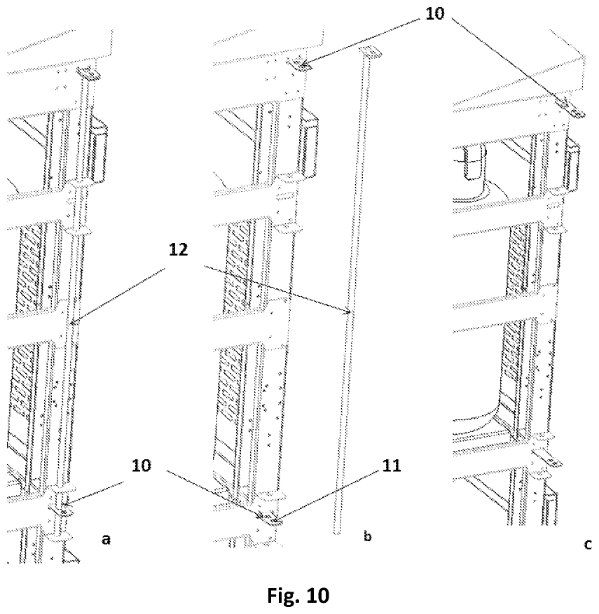

FIG. 10—service mechanism.

FIG. 1 presents a two-sided device (1) for exchanging gas cylinders in the form of a, so-called, cage, in a perspective view. The device (1) consists of four rows of boxes (2), placed in two rows on two sides of the device (1). Such an arrangement of boxes (2) allows simultaneous exchange of cylinders of various types with each row used to exchange a certain type of cylinder. Adjacent boxes (2) in one row have a common, openwork side wall. When the device is full of full bottles ready for exchanging, the extreme right box (2) is empty and open. The other boxes (2) with closed doors (3) hold full cylinders. During the exchange, the customer places an empty cylinder in the empty box (2). Opening the lock (4) with the key (5) allows the door (3) to be moved towards the empty box (2), i.e. closing the empty cylinder and opening the box (2) with the full cylinder. This solution allows the cylinder to be replaced without the presence of personnel operating the device. The customer only needs a key (5) that they can purchase at a nearby point of sale.

FIG. 2 is an enlarged view of a fragment of the device including two boxes (2). The lock (4) is mounted in the beam (6) between the two boxes (2). The door (3) is mounted on a rail (18) above the box (2).

FIG. 3 shows the upper mounting of the lower row door (3) and the lower mounting of the upper row door (3). The door in the guide (18) is moved along the linear slide bearing (19). In the lower part the door (3) is bent towards the box (2) and a roller bearing (20) is installed in the bend, which, by sliding on the bar (22), facilitates the free movement of the door (3) and prevents it from being pulled out.

FIG. 4 shows various views of the door (3) with the cover (7) of the key (4) visible. The said cover prevents removal of the key after opening the box (2), i.e. after moving the door towards the box with the deposited empty bottle. Preferably, the cover (7) is made in such a manner that it covers the key on three sides, as shown in the rear view, i.e. showing the inner side of the door (3). Above the notch revealing the lock there is a projection (23) co-operating with the door block (17). When the key (5) is turned in the lock (4) the door block (17) moves down to a height below the projection (23), allowing the door (3) to be moved (see FIG. 5). In the upper part of the door, on the inside there is the mount (21) of the slide bearing (19) and in the bottom, in the bend, there is a roller bearing (20).

The lock is covered with an escutcheon (13), visible in FIG. 5, containing the cylinder type designation (here, for example, the letter A) and the slot (14), which allows inserting a key only of a certain type, according to the designation on the escutcheon. This allows identical locks (4) to be used in the entire device (1), even if different types of cylinders are sold.

FIG. 6 shows the checking mechanism preventing the exchange for a full cylinder without depositing an empty cylinder. Device (1) according to the present embodiment has a weighing mechanism including a weighing plate (15) and tie-rod (16). The tie-rod (16) has a protrusion in the lower part and a longitudinal part placed in the beam (6) and connected by a spring (24) with the lock block (25) (see FIG. 7). The plate forms the bottom of the box (2). It is hinge-mounted on two bushings. After the empty cylinder is set on the plate (15) of the free box (2), the loaded weighing plate rests on the other two bushings and pulls down on the protrusion of the tie-rod (16). The tie-rod (16) releases the lock block (25) through the spring (24) allowing the key to be turned in the lock (4) (FIG. 7). The spring (24) is selected accordingly to the weight of the empty cylinder to be deposited.

FIG. 8 shows a door-blocking mechanism preventing the door from sliding in the direction opposite to the direction in which the door can be moved after opening the lock. The said mechanism is designed to prevent the removal of the deposited empty cylinder and, together with the cover (7), the removal of the key (5) after the purchase of the full cylinder. The reversing block mechanism includes a toothed bar (8) mounted on the door (3) and a ratchet mechanism (9) mounted in the device (1) housing. Therefore, the door (3) can only be moved one way, i.e. towards the box (2) with the deposited empty bottle. To the right in case of the device (1) shown in the figures.

In order to allow the device (1) to be refilled with full cylinders and provide for a corresponding movement of the door (3), the device has a service mechanism (FIG. 10) for prying open the ratchet mechanism (9) and releasing the toothed bar (8). The service mechanism includes a rod (10) fixed in the device (1) parallel to the toothed bar (8), used to pry open the ratchet mechanism (9). At one end, located at the side wall of the device, the rod is provided with an opening (11) through which the pin (12) blocking the rod (10) passes (FIG. 10a). In normal operations, the pin is secured with a padlock (not shown in the figure), preferably hidden under a rain cover. To fill the device (1) with full cylinders, remove the padlock and take out the pin from the device (1), in particular, from the opening (11) in the rod (10) (FIG. 10b). This allows the bar (10) to be slid out (FIG. 10c), which in this position pries open the ratchet mechanism (9) and allows the door (3) to be moved in any direction (FIG. 9).

1. A device for self-service exchange of cylinders comprising:
n unilaterally opened boxes for a cylinder, arranged in such a manner that open walls of the boxes are substantially in one plane, with n being greater than and wherein the boxes are arranged in a row, at one height,
at least one sliding door with a size allowing at least one box to be closed and slide-mounted, so that opening one box by sliding the door causes the closing of another box, and a
a key lock, configured and arranged such that when it is in an open position, it enables a closed box to be opened by a sliding of the door, and when it is in a closed position, it prevents the door from moving by a distance thereby enabling access to the box.

2. The device according to claim 1, wherein the boxes are arranged in a row and at one height.

3. The device according to claim 1 wherein the lock is mounted in at least one of the device housing, a beam an between two boxes.

4. The device according to claim 1 wherein the door is equipped with a cover, for the key, attached to the lock, in such a manner that sliding the door, after opening the lock, causes the key, placed in the lock, to be covered.

5. The device according to claim 1, further comprising a door blocking mechanism preventing the door from sliding in a direction opposite to the direction in which the door can be moved after opening the lock.

6. The device according to claim 5, wherein the reversing block mechanism comprises a toothed bar and a ratchet mechanism, of which one is mounted on the door.

7. The device according to claim 6, further comprising a service mechanism configured and arranged to pry open the ratchet mechanism and release the toothed bar.

8. The device according to claim 7, wherein the service mechanism includes a rod for prying open the ratchet mechanism, which is on at least one end provided with an opening through which a pin blocking the rod can pass.

9. The device according to claim 1, further comprising an escutcheon covering the lock with a slot for the key allowing only a key of at least one of a particular type and a designation of a cylinder type.

10. The device according to claim 1, further comprising a checking mechanism arranged and configured to prevent opening the box without depositing an empty cylinder in an empty box.

11. The device according to claim 10, wherein the checking mechanism is a weighing mechanism.

12. The device according to claim 11, wherein the weighing checking mechanism comprises a plate adapted for placement of a cylinder thereon and a tie-rod arranged and configured such that when the weighing plate is loaded, the tie-rod releases the lock block thereby enabling the key to turn in the lock.

13. The device according to claim 12, wherein the tie-rod is mounted in a beam.

14. The device according to claim 1, wherein the door is mounted on a guide including a slide bearing arranged and configured with the guide so as to enable movement of the door.

15. The device according to claim 1, wherein a lower part of the door is bent towards the box and in the bend a roller bearing is arranged and configured to slide along a bar attached to the device.

16. The device according to claim 2, wherein the boxes are arranged side-by-side or such that adjacent boxes have common side walls.

17. The device according to claim 12, further comprising a spring configured and arranged to enable the tie-rod release of the lock block.
